(19) United States
(12) Patent Application Publication
(10) Pub. No.: US 2009/0117314 A1
(43) Pub. Date: May 7, 2009

(54) PROCESS FOR THE PREPARATION OF POLYCARBONATE BY THE MELT TRANSESTERIFICATION METHOD

(75) Inventors: Wilfried Haese, Odenthal (DE); Alexander Meyer, Duesseldorf (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/266,152

(22) Filed: Nov. 6, 2008

(30) Foreign Application Priority Data
Nov. 7, 2007 (DE) 102007052968.8

(51) Int. Cl. B32B 3/02; C08G 64/30

(52) U.S. Cl. 428/64.7; 528/302; 528/274; 528/275

(57) ABSTRACT

The invention relates to a process for the preparation of polycarbonate by the melt transesterification method, polycarbonate having a small buildup of electrostatic charge and obtainable by this process and shaped articles or extrudates, in particular optical data stores or diffuser discs, comprising this polycarbonate.

### RELATED APPLICATIONS

This application claims benefit to German Patent Application No. 10 2007 052 968.8, filed Nov. 7, 2007, which is incorporated herein by reference in its entirety for all useful purposes.

### BACKGROUND OF THE INVENTION

The invention relates to a process for the preparation of polycarbonate by the melt transesterification method, polycarbonate having a small buildup of electrostatic charge obtainable by this process and shaped articles or extrudates, in particular optical data stores or diffuser discs, comprising this polycarbonate.

Optical data storage materials are being increasingly used as a variable recording and/or archiving medium for large quantities of data. Examples of this type of optical data stores are CD, super audio CD, CD-R, CD-RW, DVD, DVD-R, DVD+R, DVD-RW, DVD+RW, HD-DVD and BD.

Transparent thermoplastics, such as, for example, polycarbonate, polymethyl methacrylate and chemical modifications thereof, are typically used for optical storage media. Polycarbonate as substrate material is suitable in particular for non-rewritable and rereadable and also for rewritable optical discs and for the production of shaped articles from the area of automotive glazings, such as, for example, of diffuser discs. This thermoplastic has excellent mechanical stability, is not very susceptible to dimensional changes and is distinguished by high transparency and impact strength.

According to DE-A 2 119 799, polycarbonates can be prepared with participation of phenolic terminal groups by the phase-boundary method as well as the method in the homogeneous phase.

A further industrially used process for the preparation of polycarbonate is the melt transesterification method. Polycarbonate prepared by this method can in principle be used for the production of optical data stores of the formats described above, such as, for example, for compact discs (CD) or digital versatile discs (DVD).

However, this method has to date the disadvantage that it gives polycarbonates which, after processing to injection moulded bodies, have the property of building up high electric fields on the surface of the injection moulded articles. Thus, for example, discs for optical data stores comprising this polycarbonate build up a high electric field during their production by the injection moulding process. This high field strength on the substrate leads during the production of the optical data stores, for example, to the attraction of dust from the environment and to adhesion of the injection moulded articles, for example the discs, to one another, which reduces the quality of the finished injection moulded article and also complicates the injection moulding process.

Furthermore, the high electric field on the discs (for optical data media) leads to poor wettability, especially with nonpolar media, such as, for example, a nonpolar dye or a dye coat comprising solvents such as, for example, dibutyl ether, ethylcyclohexane, tetrafluoropropanol, cyclohexane, methylcyclohexane or octafluoropropanol. Thus, a high electric field on the surface of the substrate causes, for example, irregular and incomplete coating with dye during the dye application in the case of writable data stores and thus leads to defects in the information layer.

In the case of an optical data store in which a writable dye is applied to the surface in a spincoating process, a low absolute electric field strength is therefore required in order to guarantee the uniform application of the writable layer and to ensure a trouble-free production process.

The buildup of electrostatic charge on a substrate material leads to an electric field which can be quantified by measurement at a certain distance from the substrate surface.

On the basis of the facts described above, a further disadvantage of such a high electric field is moreover to be seen in losses of yield with respect to the substrate material. This leads to losses of production and accordingly gives rise to corresponding additional costs.

The electric field which forms in the course of the injection moulding process on the respective injection moulded parts is not constant during the production process but shows certain variation as a function of time. Thus, it is found that the field strength on the respective discs firstly changes after the beginning of the injection moulding process (assuming use of a new cavity) and reaches a stable value (plateau) only after a certain period or continues to increase only slightly. This is an important criterion for the performance of the injection-moulded part in the subsequent production step in which, for example, the dye is applied to the substrate. The buildup of the charge on injection-moulded bodies produced from polycarbonate by the melt transesterification process differs from injection-moulded bodies produced from polycarbonate by the phase-boundary method in essential aspects. The starting value of the field strength in the case of polycarbonate according to the melt transesterification process at the beginning of the injection moulding process is generally strongly in the negative range compared with polycarbonate produced by the phase-boundary method. The plateau value which is established after a certain run time, such as, for example, after 2 hours of a continuous injection moulding process, generally remains substantially in the negative range (negative field strength), in contrast to polycarbonate prepared by the phase-boundary method.

Several approaches have been taken towards solving the problem of a high electrostatic field. In general, antistatic agents are added as additives to the substrate material. Such polycarbonate compositions to which antistatic agents have been added are described, for example, in JP-A 62 207 358, wherein polyethylene or polypropylene derivatives are used as additives. Here, inter alia phosphoric acid derivatives are added as antistatic agents to the polycarbonate. EP-A 922 728 describes various antistatic agents, such as polyalkylene glycol derivatives, ethoxylated sorbitan monolaurate, polysiloxane derivatives, phosphine oxides and distearylhydroxyamine, which can be used individually or as mixtures. Japanese Application JP-A 62 207 358 describes esters of phosphorous acid as additives having antistatic activity. U.S. Pat. No. 5,668,202 describes sulphonic acid derivatives as additives.

U.S. Pat. No. 6,262,218 and U.S. Pat. No. 6,022,943 describe the use of phenyl chloroformate for increasing the terminal group content in the melt polycarbonate (polycarbonate prepared by the melt transesterification process). It is postulated therein that a terminal group content of more than 90% should have a positive effect on the electrostatic properties. In WO-A 00/50 488, 3,5-di-tert-butylphenol is used as a chain terminator in the phase-boundary method. This chain terminator leads to lower buildup of static charge on the corresponding substrate material compared with conventional chain terminators. EP-A 1 304 358 describes the use of short oligomers, such as, for example, bisphenol A bis(4-tert-butylphenylcarbonate), as additives in polycarbonate from the melt transesterification process.

However, the additives described may have a disadvantageous effect on the properties of the substrate material since, at high temperatures, they tend to emerge from the material and may thus lead to the formation of deposits or poor moulding. Furthermore, the content of oligomers in the polycarbonate may also lead to a poorer level of mechanical properties and to a reduction in the glass transition temperature. Furthermore, these additives may cause secondary reactions as additives. Consequently, the thermal stability of the base material may be reduced. The subsequent “endcapping” of polycarbonate which was obtained from the transesterification process is complicated. The substances required for this purpose have to be prepared, which is associated with additional costs and an additional process step for the subsequent “endcapping”.

Furthermore, it is known that various acids or acid derivatives can be added to polycarbonates as additives. Thus, for example, JP-A 07-247351 describes the use of aliphatic hydroxycarboxylic acids as a chelating component of the catalyst system in the preparation of polycarbonates. In US-A 2005/0113534, inter alia hydroxycarboxylic acids are used during the compounding for stabilizing a polycarbonate/polyester blend. US-A 2005/0171323 describes copolycarbonates which have special structures of quinone derivatives. For stabilizing these copolycarbonates, inter alia hydroxycarboxylic acids are added as antioxidants during the polycondensation. EP-A 435 124 describes the addition of weak acids for neutralizing the basic catalysts to the finished polycarbonate. EP-A 460 646 likewise describes the addition of aliphatic carboxylic acids to the finished polycarbonate powder or granules, in particular to that prepared by the phase-boundary method, for such stabilization purposes. However, an advantageous effect on the buildup of electrostatic charge on the resulting products was not observed in the case of any of the above-described additions of additives.

In DE-A 10 2004 061 754, DE-A 10 2004 061 715, US-A 2006/135736, US-A 2006/135735 and US-A 2006/134366 describe materials which are particularly suitable for production of low-charge injection-moulded bodies. However, these are exclusively those polycarbonates which were prepared by the phase-boundary method. The measures described have no effect in the case of the melt transesterification method.

In order to guarantee good coatability of optical data stores in the production process, so-called ionizers which pass an ionized air stream over the discs are frequently used. However, the use of ionizers makes the production process more expensive so that, for an economical process, the number of ionizers to be used should be reduced to a minimum.

It was also furthermore found that, for the coatability of an injection-moulded body, not only is the level of the electric field relevant but also the charge homogeneity on the injection-moulded body—for example an optical disc—plays an important role. Thus, for example, a low average electric field strength can be measured altogether on the total disc. However, a high positive electric field strength may be present in some surface sectors and a very low field strength in others. These charge differences lead to poor wettability although the measured average field may have acceptable values. For this reason, not only the absolute average value of the electric field strength but also the variations of the field strength (field strength variation) measured over a certain radius of the injection-moulded body is of considerable interest for optimum wettability.

Thus, there continued to be a need for a process for the preparation of polycarbonate by the melt transesterification method, which process is suitable for processing to mouldings or extrudates having a small buildup of electrostatic charge. Furthermore, in addition to the requirement for as small an average electric field strength (magnitude) as possible on corresponding shaped articles, there was a need for as small a field strength variation as possible on the substrate surface.

It was therefore the object to provide a melt transesterification process and a polycarbonate prepared by this process, which, after processing to give a moulding or extrudate, meets the requirements for as small a buildup of charge as possible on the substrate surface in combination with a small charge variation and which avoids the disadvantages described above.

### EMBODIMENTS OF THE INVENTION

An embodiment of the present invention is a process for preparing polycarbonate by the melt transesterification method comprising reacting at least one dihydroxyaryl compound with at least one diarylcarbonate in the presence of at least one catalyst in a multistage process, wherein at least one inhibitor is added to the melt before the last reaction stage and one or more aliphatic hydroxydicarboxylic acid(s) and/or hydroxypolycarboxylic acid(s) or derivative(s) thereof are added in or after the last reaction stage.

Another embodiment of the present invention is the above process, wherein said one or more aliphatic hydroxydicarboxylic acid(s) and/or hydroxypolycarboxylic acid(s) or derivative(s) thereof are one or more compound(s) of general formulae (VI) or (VII)

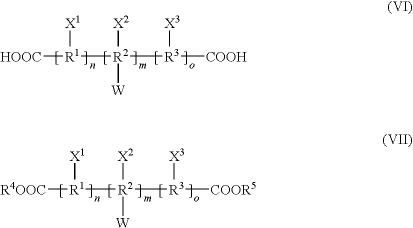

wherein
R¹, R², and R³
   are, independently of one another, a linear or branched C₁-C₁₀-alkylene radical;
X¹, X², and X³
   are, independently of one another, H or OH, wherein at least one of X¹, X², or X³ represent OH;
W is H, COOH, a carboxylate, or alkylcarboxyl;
n is an integer from 1 to 3;
m is 0 or an integer from 1 to 3;
o is 0 or an integer from 1 to 3; and
R⁴ and R⁵
   are, independently of one another, a linear or branched C₁-C₁₀-alkyl radical or an alkali metal cation, preferably Li⁺, Na⁺ or K⁺.

Another embodiment of the present invention is the above process, wherein
R¹, R², and R³
   are, independently of one another, a linear, C₁-C₆-alkylene radical;
W is COOH;
n is 1;
m is 0 or 1;
o is 0 or 1; and
R⁴ and R⁵
   are, independently of one another, a linear or branched C₁-C₆-alkyl radical.

Another embodiment of the present invention is the above process, wherein said one or more aliphatic hydroxydicarboxylic acid(s) and/or hydroxypolycarboxylic (s) or derivative(s) thereof are one or more compound(s) selected from the group consisting of malic acid, malic acid esters, malic acid monoesters, tartaric acid, tartaric acid esters, tartaric acid monoesters, hydroxymalonic acid, hydroxymalonic acid esters, citric acid, and citric acid esters.

Another embodiment of the present invention is the above process, wherein said at least one inhibitor is a sulphur-containing acid, an ester of an organic sulphur-containing acid, or mixtures thereof.

Another embodiment of the present invention is the above process, wherein said at least one dihydroxyaryl compound is selected from the group consisting of dihydroxybenzenes, dihydroxybiphenyls, bis(hydroxyphenyl)alkanes, bis(hydroxyphenyl)cycloalkanes, bis(hydroxyphenyl)aryls, bis(hydroxyphenyl)ethers, bis(hydroxyphenyl)ketones, bis(hydroxyphenyl)sulphides, bis(hydroxyphenyl)sulphones, bis(hydroxyphenyl) sulphoxides, 1,1′-bis(hydroxyphenyl)diisopropylbenzenes, and derivatives thereof alkylated or halogenated on the nucleus.

Another embodiment of the present invention is the above process, wherein said at least one diarylcarbonate has a general formula (II)

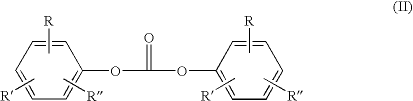

wherein
R, R′, and R″,
   are, independently of one another, hydrogen, linear, or branched C₁-C₃₄-alkyl, C₇-C₃₄-alkylaryl, or C₆-C₃₄-aryl, wherein R—is optionally COO—R′″, wherein R′″ is hydrogen, linear or branched C₁-C₃₄-alkyl, C₇-C₃₄-alkylaryl, or C₆-C₃₄-aryl.

Another embodiment of the present invention is the above process, wherein said at least one catalyst is a compound selected from the group consisting of alkali metal salts, alkaline earth metal salts, and onium salts.

Another embodiment of the present invention is the above process, wherein said at least one catalyst is an onium salt.

Yet another embodiment of the present invention is a polycarbonate prepared by the above process, wherein said polycarbonate comprises one or more aliphatic hydroxydicarboxylic acid(s) and/or hydroxypolycarboxylic acid(s) or derivative(s) thereof in an amount of from 5 to 500 ppm and has a content of phenolic terminal OH groups of more than 150 ppm.

Yet another embodiment of the present invention is a shaped article or extrudate comprising the above polycarbonate.

Yet another embodiment of the present invention is an optical data store or diffuser disc comprising the above polycarbonate.

Yet another embodiment of the present invention is an optical disc having a mean electric field strength of −20 to +20 kV/m and a field strength variation of less than 15 kV/m for producing optical data stores comprising a polycarbonate comprising one or more aliphatic hydroxydicarboxylic acid(s) and/or hydroxypolycarboxylic acid(s) or derivative(s) thereof in an amount of from 5 to 500 ppm and which has a content of phenolic terminal OH groups of more than 150 ppm.

### DESCRIPTION OF THE INVENTION

This object is surprisingly achieved if, in a multistage melt transesterification process, at least one inhibitor is added to the melt before the last reaction stage and one or more aliphatic hydroxydicarboxylic acid(s) and/or hydroxypolycarboxylic acid(s) or a derivative or derivatives thereof are added in or after the last reaction stage. Polycarbonates prepared by the process according to the invention do not have the abovementioned disadvantages and are outstandingly suitable for processing to give mouldings or extrudates having a small and homogeneous buildup of electrostatic charge.

The present invention therefore relates to a process for the preparation of polycarbonate by the melt transesterification method, at least one dihydroxyaryl compound being reacted with at least one diarylcarbonate with the use of at least one catalyst in a multistage process, characterized in that at least one inhibitor is added to the melt before the last reaction stage and one or more aliphatic hydroxydicarboxylic acid(s) and/or hydroxypolycarboxylic acid(s) or a derivative or derivatives thereof are added in or after the last reaction stage.

With the polycarbonate prepared by the process according to the invention, it is possible to produce injection-moulded bodies, such as, for example, discs for optical data media, having values for the average electric field strength of −20 to +20 kV/m in combination with a small field strength variation of less than 15 kV/m.

The process according to the invention is effected by the melt transesterification method. The preparation of aromatic oligo- or polycarbonates by the melt transesterification method is known from the literature and is described, for example, in Encyclopedia of Polymer Science, Vol. 10 (1969), Chemistry and Physics of Polycarbonates, Polymer Reviews, H. Schnell, Vol. 9, John Wiley and Sons, Inc. (1964), pages 44-51. and in DE-C 10 31 512, U.S. Pat. No. 3,022,272, U.S. Pat. No. 5,340,905 and U.S. Pat. No. 5,399,659.

According to this process, aromatic dihydroxy compounds are subjected to transesterification with carbonic acid diesters with the aid of suitable catalysts and optionally further additives in the melt.

The process is effected in a plurality of stages, as a rule in reactors which are connected in series and in which the molecular weight and hence the viscosity of the polycarbonate is increased stepwise.

For carrying out the process according to the invention, for example, it is possible to use a plant design as shown in WO-A 02/077 067. The polycarbonate synthesis is carried out by transesterification of diaryl carbonates with dihydroxyaryl compounds in the presence of quaternary onium compounds, an oligocarbonate being prepared in a plurality of evaporator stages at temperatures increasing stepwise and pressures decreasing stepwise, which oligocarbonate is subjected to condensation in one or two basket reactors connected in series at further increasing temperatures and decreasing pressures to give the polycarbonate.

Dihydroxyaryl compounds suitable for the process according to the invention are those of the general formula (I)

HO-Z-OH (I)

in which Z is an aromatic radical which has 6 to 34 C atoms and may contain one or more optionally substituted aromatic nuclei and aliphatic or cycloaliphatic radicals or alkylaryls or heteroatoms as bridge members.

Examples of suitable dihydroxyaryl compounds are: dihydroxybenzenes, dihydroxybiphenyls, bis(hydroxyphenyl)alkanes, bis(hydroxyphenyl)cycloalkanes, bis(hydroxyphenyl)aryls, bis(hydroxyphenyl)ethers, bis(hydroxyphenyl)ketones, bis(hydroxyphenyl)sulphides, bis(hydroxyphenyl)sulphones, bis(hydroxyphenyl) sulphoxides, 1,1′-bis(hydroxyphenyl)diisopropylbenzenes and the compounds thereof which are alkylated on the nucleus or halogenated on the nucleus.

These and further suitable other dihydroxyaryl compounds are described, for example, in DE-A 3 832 396, FR-A 1 561 518, in H. Schnell, Chemistry and Physics of Polycarbonates, Interscience Publishers, New York 1964, page 28 et seq.; page 102 et seq. and in D. G. Legrand, J. T. Bendler, Handbook of Polycarbonate Science and Technology, Marcel Dekker New York 2000, page 72 et seq.

Preferred dihydroxyaryl compounds are, for example, resorcinol, 4,4′-dihydroxybiphenyl, bis(4-hydroxyphenyl)methane, bis(3,5-dimethyl-4-hydroxyphenyl)methane, bis(4-hydroxyphenyl)diphenylmethane, 1,1-bis(4-hydroxyphenyl)-1-phenylethane, 1,1-bis(4-hydroxyphenyl)-1-(1naphthyl)ethane, 1,1-bis(4-hydroxyphenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bis(4-hydroxyphenyl)-4-methylcyclohexane, 1,1-bis(4-hydroxyphenyl)-3,3,5-trimethylcyclohexane, 1,3-bis[2-(4-hydroxyphenyl)-2-propyl]benzene, 1,1′-bis(4-hydroxyphenyl)-3-diisopropylbenzene, 1,1′-bis(4-hydroxyphenyl)-4-diisopropylbenzene, 1,3-bis[2-(3,5-dimethyl-4-hydroxyphenyl)-2-propyl]benzene, bis(4-hydroxyphenyl)ether, bis(4-hydroxyphenyl)sulphide, bis(4-hydroxyphenyl)sulphone, bis(3,5-dimethyl-4-hydroxyphenyl)sulphone and 2,2′,3,3′-tetrahydro-3,3,3′,3′-tetramethyl-1,1′-spirobi[1H-indene]-5,5′-diol.

Particularly preferred dihydroxyaryl compounds are resorcinol, 4,4′-dihydroxybiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4,4′-dihydroxybiphenyl, 2,2-bis(4-hydroxyphenyl)propane and bis(4-hydroxyphenyl)-3,3,5-trimethylcyclohexane.

It is possible to use both a dihydroxyaryl compound with formation of homopolycarbonates and different dihydroxyaryl compounds with formation of copolycarbonates.

The dihydroxyaryl compounds can also be used with residual contents of the monohydroxyaryl compounds from which they were prepared, and the low molecular weight oligocarbonates with residual contents of the monohydroxyaryl compounds which were eliminated during the preparation of the oligomers. The residual contents of the monohydroxyaryl compounds may be up to 20% by weight, preferably up to 10% by weight, particularly preferably up to 5% by weight and very particularly preferably up to 2% by weight.

The diaryl carbonates suitable for the reaction with the dihydroxyaryl compounds are those of the general formula (II)

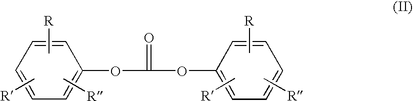

in which
R, R′ and R″, independently of one another, are identical or different and represent hydrogen, linear or branched C₁-C₃₄-alkyl, C₇-C₃₄-alkylaryl or C₆-C₃₄-aryl, and R may furthermore denote —COO—R′″, R′″ representing hydrogen, linear or branched C₁-C₃₄-alkyl, C₇-C₃₄-alkylaryl or C₆-C₃₄-aryl.

Preferred diaryl carbonates are, for example, diphenyl carbonate, methylphenyl phenyl carbonates, di(methylphenyl)carbonates, 4-ethylphenyl phenyl carbonate, di(4-ethylphenyl)carbonate, 4-n-propylphenyl phenyl carbonate, di(4-n-propylphenyl) carbonate, 4-isopropylphenyl phenyl carbonate, di(4-isopropylphenyl)carbonate, 4-n-butylphenyl phenyl carbonate, di(4-n-butylphenyl)carbonate, 4-isobutylphenyl phenyl carbonate, di(4-isobutylphenyl)carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl)carbonate, 4-isooctylphenyl phenyl carbonate, di(4-isooctylphenyl)carbonate, 4-n-nonylphenyl phenyl carbonate, di(4-n-nonylphenyl)carbonate, 4-cyclohexylphenyl phenyl carbonate, di(4-cyclohexylphenyl)carbonate, 4-(1-methyl-1-phenylethyl)phenyl phenyl carbonate, di[4-(1-methyl-1-phenylethyl)phenyl]carbonate, biphenyl-4-yl phenyl carbonate, di(biphenyl-4-yl)carbonate, 4-(1-naphthyl)phenyl phenyl carbonate, 4-(2-naphthyl)phenyl phenyl carbonate, di[4-(1-naphthyl)phenyl]carbonate, di-[4-(2-naphthyl)phenyl]carbonate, 4-phenoxyphenyl phenyl carbonate, di(4-phenoxyphenyl)carbonate, 3-pentadecylphenyl phenyl carbonate, di(3-pentadecylphenyl)carbonate, 4-tritylphenyl phenyl carbonate, di(4-tritylphenyl)carbonate, methyl salicyl phenyl carbonate, di(methylsalicyl)carbonate, ethylsalicyl phenyl carbonate, di(ethylsalicyl)carbonate, n-propylsalicyl phenyl carbonate, di(n-propylsalicyl)carbonate, isopropylsalicyl phenyl carbonate, di(isopropylsalicyl) carbonate, n-butylsalicyl phenyl carbonate, di(n-butylsalicyl)carbonate, isobutylsalicyl phenyl carbonate, di(isobutylsalicyl)carbonate, tert-butylsalicyl phenyl carbonate, di(tert-butylsalicyl) carbonate, di(phenylsaticyl)carbonate and di(benzylsalicyl)carbonate.

Particularly preferred diaryl compounds are diphenyl carbonate, 4-tert-butylphenyl phenyl carbonate, di(4-tert-butylphenyl)carbonate, biphenyl-4-yl phenyl carbonate, di(biphenyl-4-yl)carbonate, 4-(1-methyl-1-phenylethyl)phenyl phenyl carbonate, di[4-(1-methyl-1-phenylethyl)phenyl]carbonate and di(methylsalicyl)carbonate.

Diphenyl carbonate is very particularly preferred.

It is possible to use both one diaryl carbonate and different diaryl carbonates.

The diaryl carbonates may also be used with residual contents of the monohydroxyaryl compounds from which they were prepared. The residual contents of the monohydroxyaryl compounds may be up to 20% by weight, preferably up to 10% by weight, particularly preferably up to 5% by weight and very particularly preferably up to 2% by weight.

Based on the dihydroxyaryl compound(s), in general 1.02 to 1.30 mol of the diaryl carbonate(s), preferably 1.04 to 1.25 mol, particularly preferably 1.045 to 1.22 mol, very particularly preferably 1.05 to 1.20 mol, per mole of dihydroxyaryl compound are used. It is also possible to use mixtures of the abovementioned diaryl carbonates, the molar amounts per mole of dihydroxyaryl compound which are mentioned above then being based on the total amount of the mixture of the diaryl carbonates.

For controlling or changing the terminal groups, one or more monohydroxyaryl compound(s) which were not used for the preparation of the diaryl carbonate(s) used can additionally be employed. These may be those monohydroxyaryl compounds of the general formula (III)

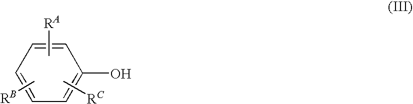

in which
R^{A} represents linear or branched C₁-C₃₄-alkyl, C₇-C₃₄-alkylaryl, C₆-C₃₄-aryl or —COO—R^{D}, R^{D} representing hydrogen, linear or branched C₁-C₃₄-alkyl, C₇-C₃₄-alkylaryl or C₆-C₃₄-aryl, and
R^{B}, R^{C} independently of one another, are identical or different and represent hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol 4-ethylphenol, 4-n-propylphenol, 4-isopropylphenol, 4-n-butylphenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl saticylate, n-propyl saticylate, isopropyl salicylate, n-butyl salicylate, isobutyl salicylate, tert-butyl salicylate, phenyl salicylate and benzyl salicylate.

4-tert-Butylphenol, 4-isooctylphenol and 3-pentadecylphenol are preferred.

The monohydroxyaryl compound(s) should be chosen so that the melting point thereof is above that of the monohydroxyaryl compound which was used for the preparation of the diaryl carbonate used. The monohydroxyaryl compound may be added at any time in the course of the reaction. It is preferably added at the beginning of the reaction. The proportion of free monohydroxyaryl compound may be 0.2 to 20 mol %, preferably 0.4 to 10 mol %, based on the dihydroxyaryl compound.

It is also possible to change the terminal groups of the resulting polycarbonates by addition of at least one additional diaryl carbonate, the base monohydroxyaryl compound of which has a higher boiling point than the base monohydroxyaryl compound of the diaryl carbonate mainly used. Here too, the additional diaryl carbonate may be added at any time in the course of the reaction. It is preferably added at the beginning of the reaction. The proportion of the diaryl carbonate having the higher-boiling base monohydroxyaryl compound, based on the total amount of diaryl carbonate used, may be 1 to 40 mol %, preferably 1 to 20 mol % and particularly preferably 1 to 10 mol %.

Catalysts which may be used in the melt transesterification method for the preparation of polycarbonates are the basic catalysts known in the literature, such as, for example, alkali metal and alkaline earth metal hydroxides and oxides and/or onium salts, such as, for example, ammonium or phosphonium salts. Preferably onium salts, particularly preferably phosphonium salts, are used in the synthesis. Such phosphonium salts are, for example those of the general formula (IV)

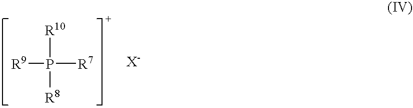

in which
R⁷⁻¹⁰ represent identical or different optionally substituted C₁-C₁₀-alkyl-, C₆-C₁₄-aryl-, C₇-C₁₅-arylalkyl or C₅-C₆-cycloalkyl radicals, preferably methyl or C₆-C₁₄-aryl, particularly preferably methyl or phenyl, and
X⁻ represents an anion selected from the group consisting of hydroxide, sulphate, hydrogen sulphate, bicarbonate, carbonate, halide, preferably chloride, and alkylate or arylate of the formula —OR¹¹, in which R¹¹ represents an optionally substituted C₆-C₁₄-aryl-, C₇-C₁₅-arylalkyl or C₅-C₆-cycloalkylrest, C₁-C₂₀-alkyl, preferably phenyl.

Particularly preferred catalysts are tetraphenylphosphonium chloride, tetraphenylphosphonium hydroxide and tetraphenylphosphonium phenolate, very particularly preferably tetraphenylphosphonium phenolate.

The catalysts are preferably used in amounts of 10⁻⁸ to 10⁻³ mol, particularly preferably in amounts of 10⁻⁷ to 10⁻⁴ mol, based on one mole of dihydroxyaryl compound.

It is optionally also possible to use cocatalysts in order to increase the rate of the polycondensation.

These may be, for example, alkaline salts of alkali metals and alkaline earth metals, such as hydroxides, optionally substituted C₁-C₁₀-alkoxides and C₆-C₁₄-aryloxides of lithium, sodium and potassium, preferably hydroxides, optionally substituted C₁-C₁₀-alkoxides or C₆-C₁₄-aryloxides of sodium. Sodium hydroxide, sodium phenolate or the disodium salt of 2,2-bis(4-hydroxyphenyl)propane are preferred.

If alkali metal or alkaline earth metal ions in the form of their salts are introduced, the amount of alkali metal or alkaline earth metal ions, determined, for example, by atomic absorption spectroscopy, is 1 to 500 ppb, preferably 5 to 300 ppb and most preferably 5 to 200 ppb, based on polycarbonate to be formed. In preferred embodiments of the process according to the invention, however, no alkali metal salts are used.

In the context of the present invention, ppb and ppm are to be understood as meaning parts by weight, unless stated otherwise.

The alkaline salts of alkali metals and alkaline earth metals can be admixed during the preparation of the oligocarbonates themselves, i.e. at the beginning of the synthesis, or in a subsequent process step, in order to suppress undesired secondary reactions. The total amount of catalyst may also be added to the process in a plurality of steps.

In addition to the catalysts and amounts of catalysts already mentioned above, it is furthermore possible to add supplementary amounts of onium catalysts before the polycondensation. If the abovementioned catalyst is itself an onium catalyst, the onium catalyst to be added in supplementary amounts before the polycondensation may be the same abovementioned onium catalyst or an onium catalyst differing therefrom.

The addition of the catalysts is preferably effected in solution in order to avoid harmful excess concentrations during the metering. The solvents are preferably compounds inherent to the system and the process, such as, for example, the dihydroxyaryl compounds, diaryl carbonates or optionally monohydroxyaryl compounds used. Monohydroxyaryl compounds are particularly suitable because the person skilled in the art is familiar with the fact that the dihydroxyaryl compounds and diaryl carbonates readily begin to change and decompose at even slightly elevated temperatures, in particular under the action of catalysts. The polycarbonate qualities may suffer as a result. In a particularly preferred embodiment of the process according to the invention, the solvent for the catalyst is phenol. In this embodiment of the process according to the invention, phenol is particularly suitable because the catalyst tetraphenylphosphonium phenolate preferably used in this embodiment is isolated as a solid solution with phenol during its preparation.

The polycarbonates which are obtained by this process are distinguished structurally in that, in addition to the chain ends capped by phenols of the formula (III), they also carry a certain proportion of uncapped phenolic terminal groups. This structure element can be described by way of example by the following formula (V)

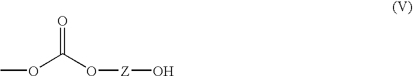

in which Z has the meaning stated for the general formula (I).

The content of phenolic terminal OH groups is preferably more than 150 ppm, particularly preferably more than 250 ppm, very particularly preferably more than 350 ppm (based on the weight of the polycarbonate).

The polycarbonates can be branched in a targeted manner by adding suitable branching agents to the reaction mixture. Suitable branching agents for the preparation of the polycarbonate are known to the person skilled in the art. These are compounds having three or more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl]propane, 2,4-bis(4-hydroxyphenylisopropyl)phenol and tetra(4-hydroxyphenyl)methane.

Other suitable compounds having three or more functional groups are, for example, 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The branching agents are generally used in amounts of, for example, 0.02 to 3.6 mol %, based on the dihydroxyaryl compound.

The dihydroxyaryl compounds, diaryl carbonates and monohydroxyaryl compounds used and also all other raw materials, chemicals and auxiliaries added to the synthesis may be contaminated with impurities originating from their own synthesis, handling and storage and are used without further purification. However, it is desirable, but not essential, to work with raw materials, chemicals and auxiliaries which are as pure as possible.

The addition of at least one inhibitor is effected before the last reaction stage. In the context of the invention, this means that the addition can be effected in at least one reaction stage before the last reaction stage or between two reaction stages. This addition is preferably effected in the reaction stage immediately before the last reaction stage or between the penultimate and last reaction stage.

Polycarbonates which are prepared by the melt transesterification method may contain catalytically active, basic impurities after the preparation. These may be firstly slight contaminations of the starting substances which have not been separated off, basic residues of thermally decomposable catalysts which have not been separated off or stable basic catalyst salts which have not been separated off. Thermally decomposable catalysts are to be understood as meaning, for example, the onium salts described above. Thermally stable catalysts are to be understood as meaning, for example, alkaline salts of the alkali metals or alkaline earth metals. For inhibiting these catalytically active, basic impurities, certain inhibitors may be added to the polycarbonates in principle at different times in the respective process.

Suitable inhibitors are acid components, such as Lewis or Brönsted acids or esters of strong acids. The pKa value of the inhibitor should not be greater than 5, preferably less than 3. The acid component is or the esters thereof are added in order to deactivate the abovementioned basic impurities on reaching the desired molecular weight and ideally thus to stop the reaction. Such inhibitors are described, for example, in EP-A 1 612 231, EP-A 435 124 or DE-A 44 38 545.

Examples of suitable acid components are orthophosphoric acid, phosphorous acid, pyrophosphoric acid, hypophosphoric acid, polyphosphoric acids, benzenephosphonic acid, sodium dihydrogen phosphate, boric acid, arylboric acids, hydrochloric acid (hydrogen chloride), sulphuric acid, benzenesulphonic acid, toluenesulphonic acid, dodecylbenzenesulphonic acid and all other phenyl-substituted benzenesulphonic acids, nitric acid, acid chlorides, such as phenyl chloroformate, acetoxy-BP-A, benzoyl chloride and esters, monoesters and bridged esters of the abovementioned acids, such as, for example, toluenesulphonic acid esters, phosphoric acid esters, phosphorous acid esters, phosphonic acid esters, dimethyl sulphate, boric acid esters, arylboric acid esters and other components generating acids under the influence of water, such as triisooctylphosphine, Ultranox 640 and BDP (bisphenol diphosphate oligomer).

Preferably used inhibitors are organic sulphur-containing acids, esters or organic sulphur-containing acids or mixtures of these. The organic sulphur-containing acids may be, for example, benzenesulphonic acid, toluenesulphonic acid, trifluoromethanesulphonic acid, naphthalenesulphonic acid or sulphonated polystyrene. The esters of organic sulphur-containing acids may be, for example, dimethyl sulphonate, diethyl sulphonate, methyl, ethyl, propyl, butyl, octyl or phenyl esters of p-toluenesulphonic acid or benzenesulphonic acid. Furthermore, they may be full or partial esters of polyhydric alcohols, such as, for example, glyceryl tribenzenesulphonate, glyceryl dibenzenesulphonate, glyceryl monobenzenesulphonate, glyceryl tri-p-toluenesulphonate, glyceryl di-p-toluenesulphonate, glyceryl mono-p-toluenesulphonate, ethylene glycol dibenzenesulphonate, ethylene glycol monobenzenesulphonate, ethylene glycol di-p-toluenesulphonate, ethylene glycol mono-p-toluenesulphonate, pentaerythrityl tetrabenzenesulphonate, pentaerythrityl tribenzenesulphonate, pentaerythrityl dibenzenesulphonate, pentaerythrityl monobenzenesulphonate, pentaerythrityl tetra-p-toluenesulphonate, pentaerythrityl tri-p-toluenesulphonate, pentaerythrityl di-p-toluenesulphonate, pentaerythrityl mono-p-toluenesulphonate, trimethylolpropane tribenzenesulphonate, trimethylolpropane dibenzenesulphonate, trimethylolpropane monobenzenesulphonate, trimethylolpropane tri-p-toluenesulphonate, trimethylolpropane di-p-toluenesulphonate, trimethylolpropane mono-p-toluenesulphonate, neopentylglycol dibenzenesulphonate, neopentylglycol monobenzenesulphonate, neopentylglycol di-p-toluenesulphonate, neopentylglycol mono-p-toluenesulphonate and mixtures thereof. In addition, these mixtures may also contain residues of the starting compounds (acid component and/or alcohol component). EP-A-1 609 818 also gives an exemplary but non-limiting description of such inhibitors.

The inhibitors described can be added individually or as any desired mixtures with one another or as a plurality of different mixtures to the polymer melt.

The inhibitors can be used in amounts of less than 100 ppm, based on the polycarbonate, preferably in amounts of 0.1 to 50 ppm, based on the polycarbonate, particularly preferably 0.5 to 10 ppm and very particularly preferably in amounts of 1 to 5 ppm.

Regarding the form of addition of the inhibitors, there is no limitation. The inhibitors can be added as solid, for example as powder, in solution or as a melt to the polymer melt. Another method of metering is the use of a masterbatch, i.e. a mixture of the inhibitor with the polymer, preferably with polycarbonate, which was homogenized by compounding, which masterbatch may also contain further additives, such as, for example, other stabilizers or mould release agents.

The esters of organic sulphur-containing acids are preferably added in liquid form. Since the amounts to be metered are very small, preferably solutions of the esters or masterbatches are used.

The compounds chosen as solvents are preferably those which have already been used as another component in the respective processes. Depending on the requirements regarding the product to be prepared, any residues remaining do not reduce the desired quality.

Suitable compounds which have already been used in the respective process are preferably those which are chemically inert and vaporize rapidly. For example phenol and diphenyl carbonate are suitable as such in preferred embodiments.

All organic solvents having a boiling point at atmospheric pressure of 30 to 300° C., preferably of 30 to 250° C. and particularly preferably of 30 to 200° C. and also water—including water of crystallization—are suitable as further solvents.

Suitable solvents may be, for example, water or optionally substituted alkanes, cycloalkanes or aromatics. The substituents may be aliphatic, cycloaliphatic or aromatic radicals in different combination and halogens or hydroxyl groups. Heteroatoms, such as, for example, oxygen, may also be bridge members between aliphatic, cycloaliphatic or aromatic radicals, it being possible for the radicals to be identical or different. Further solvents may also be ketones and esters of organic acids and cyclic carbonates. Furthermore, the inhibitor can also be dissolved in glyceryl monostearate and metered in. Mixtures of the abovementioned may also be used as solvents.

Examples of such solvents in addition to water are n-pentane, n-hexane, n-heptane and isomers thereof chlorobenzene, methanol, ethanol, propanol, butanol and isomers thereof, phenol, o-, m- and p-cresol, acetone, diethyl ether, dimethyl ketone, polyethylene glycols, polypropylene glycols, ethyl acetate, ethylene carbonate, propylene carbonate and mixtures of these.

Water, phenol, propylene carbonate, ethylene carbonate, toluene and mixtures of these are preferably suitable.

Water, phenol, propylene carbonate and mixtures of these are particularly preferably suitable.

For example, static mixers or other dynamic mixers leading to homogenic mixing in, such as, for example, extruders, are suitable for effectively mixing in the inhibitor.

One or more aliphatic hydroxydicarboxylic acid(s) and/or hydroxypolycarboxylic acid(s) or derivative(s) thereof are added to the reaction mixture (reaction mixture melt) in or after the last reaction stage of the process according to the invention. The addition is accordingly preferably effected in the so-called finish reactor or after the finish reactor, particularly preferably after the finish reactor.

According to the invention, aliphatic hydroxypolycarboxylic acid(s) are to be understood as meaning those having more than two carboxyl groups. In the context of the invention, aliphatic hydroxypolycarboxylic acid(s) are preferably those having three, four or five carboxyl groups. Particularly preferred aliphatic hydroxypolycarboxylic acids are aliphatic hydroxytricarboxylic acids.

In preferred embodiments, one or more aliphatic hydroxydicarboxylic acid(s) and/or hydroxytricarboxylic acid(s) or derivative(s) thereof are added to the reaction mixture.

Derivatives of aliphatic hydroxydicarboxylic acid(s) and/or hydroxypolycarboxylic acid(s) are to be understood as meaning, for example, salts, esters, amides, halides or anhydrides of the corresponding acids, preferably esters of the corresponding acids, or carboxylic acids derivatized at the hydroxyl group, such as, for example, alkoxycarboxylic acids.

Preferred aliphatic hydroxydicarboxylic acids and/or hydroxypolycarboxylic acids or derivatives thereof are, for example, those of the general formulae (VI) and (VII), respectively,

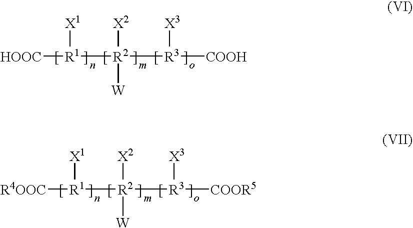

in which
R¹, R², R³, independently of one another, represent a linear or branched, preferably a linear, C₁-C₁₀-alkylene radical, particularly preferably a linear or branched, preferably linear, C₁-C₆-alkylene radical,
X¹, X², X³, independently of one another, represent H or OH, at least one of the radicals X¹, X², X³ representing OH,
W represents H, COOH, a carboxylate or alkylcarboxyl, preferably COOH,
n represents an integer from 1 to 3, preferably 1,
m represents 0 or an integer from 1 to 3, preferably 0 or 1,
o represents 0 or an integer from 1 to 3, preferably 0 or 1,
R⁴, R⁵, independently of one another, represent a linear or branched C₁-C₁₀-alkyl radical, preferably a linear or branched C₁-C₆-alkyl radical, or an alkali metal cation, preferably Li⁺, Na⁺ or K⁺, particularly preferably a linear or branched C₁-C₆-alkyl.

Particularly preferred aliphatic hydroxydicarboxylic acids and/or hydroxypolycarboxylic acids or derivatives thereof are, for example, malic acid, malic acid esters, malic acid monoesters, tartaric acid, tartaric acid esters, tartaric acid monoesters, hydroxymalonic acid or esters thereof, citric acid or esters thereof. All stereoisomers, mixtures of the stereoisomers or racemic mixtures and also mixtures of the abovementioned acids or esters are suitable and are within the scope of the invention. Tartaric acid or malic acid or derivatives thereof or mixtures of these are particularly preferred.

The aliphatic hydroxydicarboxylic acids and/or hydroxypolycarboxytic acids or derivatives thereof are used, for example, in amounts of 5 to 500 ppm, preferably 10 to 300 ppm, particularly preferably 20 to 200 ppm, based on the polycarbonate, in or after the last reaction stage of the process according to the invention.

By this combination of the addition of at least one inhibitor in a reaction stage before the last reaction stage and the addition of at least one aliphatic hydroxydicarboxylic acid and/or hydroxypolycarboxylic acid or a derivative thereof in the last reaction stage, it is possible to obtain by means of melt transesterification processes polycarbonates which lead to shaped articles having low buildup of electrostatic charge on the surface during further processing, for example by means of injection moulding. Such a combination of inhibitors and additional aliphatic hydroxydicarboxylic acids and/or hydroxypolycarboxylic acids or derivatives thereof in this specific time sequence within the process has not been described to date in the literature. The effect of the low buildup of electrostatic charge with little local variation on the surface of the resulting mouldings or extrudates is all the more surprising since, for example, the addition of inhibitors of the abovementioned type before the finish reactor without the additional addition of at least one aliphatic hydroxydicarboxylic acid and/or hydroxypolycarboxylic acid or a derivative thereof in the last reaction stage is already known (cf. for example EP-A 1 612 231 and DE-A 103 57 161) but has no positive effect at all on the electrostatic properties of the resulting mouldings or extrudates.

The process according to the invention can be carried out batchwise or continuously.

After the dihydroxyaryl compounds and diaryl carbonates, optionally with further compounds, such as, for example, a higher-boiling monohydroxyaryl compound, are present as a melt, the reaction is started in the presence of at least one suitable catalyst. The conversion or the molecular weight is increased with increasing temperatures and decreasing pressures in suitable apparatuses and devices by removing the monohydroxyaryl compound which is being eliminated until the desired end state, i.e. the desired conversion or the desired molecular weight, is reached. Through the choice of the ratio of dihydroxyaryl compound to diaryl carbonate, of the loss rate of the diaryl carbonate on the vapours, resulting from the choice of the procedure or plant for the preparation of the polycarbonate, and optionally of further compounds added, such as, for example, a higher-boiling monohydroxyaryl compound, the terminal groups are characterized in type and concentration.

In the context of the invention, C₁-C₄-alkyl, represents, for example, methyl, ethyl, n-propyl, isopropyl, n-butyl, sec-butyl, or tert-butyl; C₁-C₆-alkyl additionally represents, for example, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl or 1-ethyl-2-methylpropyl; C₁-C₁₀-alkyl additionally represents, for example, n-heptyl and n-octyl, pinacyl, adamantyl the isomeric menthyls, n-nonyl or n-decyl; C₁-C₃₄-alkyl additionally represents, for example, n-dodecyl, n-tridecyl, n-tetradecyl, n-hexadecyl or n-octadecyl. The same applies to the corresponding alkyl radical, for example, in aralkyl or alkylaryl, alkylphenyl or alkylcarbonyl radicals. Alkylene radicals in the corresponding hydroxyalkyl or aralkyl or alkylaryl radical represent for example, the alkylene radicals corresponding to the preceding alkyl radicals.

Aryl represents a carbocyclic aromatic radical having 6 to 34 skeletal carbon atoms. The same applies to the aromatic moiety of an arylalkyl radical, also referred to as aralkyl radical, and to aryl constituents of more complex groups, such as, for example, arylcarbonyl radicals.

Examples of C₆-C₃₄-aryl are phenyl, o-, p- and m-tolyl, naphthyl, phenanthrenyl, anthracenyl or fluorenyl.

Arylalkyl or aralkyl denotes, in each case independently, a straight-chain, cyclic, branched or unbranched alkyl radical according to the above definition, which may be monosubstituted, polysubstituted or completely substituted by aryl radicals according to the above definition.

The preceding lists are to be understood as being by way of example and not as limiting.

There is in principle no limitation and restriction with regard to the manner and plant in which and the procedure according to which the process is carried out. The process can preferably be carried out as described below.

Furthermore, there is no special limitation and restriction with regard to the temperatures and the pressures for the process according to the invention. Any condition is possible as long as the chosen temperatures, pressures and catalysts permit a melt transesterification with appropriately rapid removal of the monohydroxyaryl compound eliminated.

The temperatures over the entire process are in general between 180 and 330° C. and the pressures between 15 bar absolute and 0.01 mbar absolute.

A continuous procedure is preferably chosen because this may be advantageous for the product quality.

Such a continuous process according to the invention is preferably carried out in such a way that one or more dihydroxyaryl compounds are subjected to precondensation with one or more diaryl carbonate(s) and optionally further reactants with the use of at least one catalyst and the molecular weight of the end product is increased to the desired level after this precondensation without separating off the resulting monohydroxyaryl compound(s) in a plurality of subsequent reaction-evaporator stages with temperatures increasing stepwise and pressures decreasing stepwise.

The devices, apparatuses and reactors suitable for the individual reaction-evaporator stages are, corresponding to the course of the process, heat exchangers, flash apparatuses, separators, columns, evaporators, stirred containers and reactors and other commercial apparatuses which provide the required residence time at selected temperatures and pressures. The chosen devices must permit the necessary introduction of heat and be designed so that they are suitable for the continuously increasing melt viscosities.

All devices are connected to one another via pumps, pipelines and valves. The pipelines between all facilities should of course be as short as possible and the number of bends in the pipes should be kept as small as possible in order to avoid unnecessarily lengthened residence times. The external, i.e. technical boundary conditions and requirements for assemblies of chemical plants should be taken into account.

For carrying out the process according to a preferred continuous procedure, the reactants can be melted together or the solid dihydroxyaryl compound(s) in the diarylcarbonate melt or the solid diaryl carbonate or carbonates in the melt of the dihydroxyaryl compound(s) can be dissolved or both raw materials are combined as a melt, preferably directly from the preparation. The residence times of the separate melts of the raw materials, in particular those of the melt of the dihydroxyaryl compound, are set as short as possible. The melt mixture can on the other hand have a longer residence time without losses of quality owing to the lower melting point of the raw material mixture in comparison with the individual raw materials at correspondingly lower temperatures.

The catalyst or catalysts, preferably dissolved in a suitable solvent, such as, for example, phenol, is or are then admixed and the melt is heated to the reaction temperature.

In preferred embodiments of the process according to the invention, a part-stream, into which at least one inhibitor is metered, is taken off from the melt stream between the penultimate reactor and the finish reactor by means of a gear pump. Directly thereafter, the mixture is pumped back into the main stream for thorough mixing via a static mixer. Following the entry point in the direction of flow is a further static mixer which ensures the homogeneous distribution in the main melt stream, which is then passed into the final reactor. In the final reactor, which is used for reducing residual monomers, the residual monomers are then reduced at temperatures of 260 to 310° C. preferably at 265 to 300° C. and particularly preferably at 270 to 290° C. and at pressures of 0.01 to 3 mbar, preferably of 0.2 to 2.5 mbar and particularly preferably of 0.4 to 2 mbar. The levels of fill are set in the final reactor so as to be as low as permitted by the process engineering. The residence time in the final reactor—also referred to as finish reactor—is of the order of magnitude of a few minutes to hours, preferably 5 to 180 minutes, particularly preferably 10 to 150 minutes and very particularly preferably 15 to 120 minutes. A possible slight increase in molecular weight in the final reactor, in which predominantly the expulsion of the residual monomers in vapour form is to take place, can be compensated by reducing the entry molecular weight to such an extent that, after the expulsion of the residual monomers in vapour form, the desired final molecular weight is exactly achieved. The finished polycarbonate is discharged from the final reactor by means of the pump device, if required provided with additives for improving the properties by known methods, extruded, cooled and granulated. The pump device used is as a rule a gear pump. Alternatively, screws having a very wide range of designs or positive displacement pumps of special design can also be used.

The particularly preferred embodiment of the process according to the invention in which, for example, 2,2-bis(4-hydroxyphenyl)propane (bisphenol A, BPA) and diphenyl carbonate (DPC) are reacted with one another to give a polycarbonate is described below by way of example but in a nonlimiting manner:

The reaction temperature at the beginning of this particularly preferred embodiment is 180 to 220° C., preferably 190 to 210° C. very particularly preferably 190° C. During residence times of 15 to 90 min, preferably 30 to 60 min, the reaction equilibrium is established without the resulting hydroxyaryl compound being removed. The reaction can be carried out at atmospheric pressure but, for technical reasons, also at excess pressure. The preferred pressure in industrial plants is 2 to 15 bar absolute.

The melt mixture is let down into a first vacuum chamber, the pressure of which is adjusted to 100 to 400 mbar, preferably to 150 to 300 mbar, and heated to the entry temperature again directly thereafter in a suitable device at the same pressure. During the flash process, the resulting hydroxyaryl compound is vaporized with monomers still present. After a residence time of 5 to 30 min in a bottom receiver, optionally with circulation by pumping at the same pressure and the same temperature, the reaction mixture is let down into a second vacuum chamber, the pressure of which is 50 to 200 mbar, preferably 80 to 150 mbar, and directly thereafter heated to a temperature of 190 to 250° C., preferably 210 to 240° C., particularly preferably 210 to 230° C., in a suitable device at the same pressure. Here too, the resulting hydroxyaryl compound is vaporized with monomers still present. After a residence time of 5 to 30 minutes in a bottom receiver, optionally with circulation by pumping, under the same pressure and the same temperature, the reaction mixture is let down into a third vacuum chamber, the pressure of which is 30 to 150 mbar, preferably 50 to 120 mbar, and heated to a temperature of 220 to 280° C., preferably 240 to 270° C., particularly preferably 240 to 260° C. directly thereafter in a suitable device at the same pressure. Here too, the resulting hydroxyaryl compound is vaporized with monomers still present. After a residence time of 5 to 20 minutes in a bottom receiver, optionally with circulation by pumping at the same pressure and the same temperature, the reaction mixture is let down into a further vacuum chamber, the pressure of which is 5 to 100 mbar, preferably 15 to 100 mbar, particularly preferably 20 to 80 mbar, and heated to a temperature of 250 to 300° C., preferably 260 to 290° C., particularly preferably 260 to 280° C., directly thereafter in a suitable device at the same pressure. Here too, the resulting hydroxyaryl compound is vaporized with monomers still present.

The number of these stages, here 4 by way of example, may vary between 2 and 6. The temperatures and pressures should be appropriately adapted on changing the number of stages, in order to obtain comparable results. The relative viscosity of the oligocarbonate which is achieved in these stages is between 1.04 and 1.20, preferably between 1.05 and 1.15, particularly preferably between 1.06 and 1.10.

The oligocarbonate thus produced is transported into a disc or basket reactor after a residence time of 5 to 20 minutes in a bottom receiver, optionally with circulation by pumping at the same pressure and same temperature as in the last flash/evaporator stage and is subjected to further condensation at 250 to 310° C., preferably 250 to 290° C., particularly preferably 250 to 280° C., at pressures of 1 to 15 mbar, preferably 2 to 10 mbar, during residence times of 30 to 90 min, preferably 30 to 60 minutes. The product reaches a relative viscosity of 1.12 to 1.28, preferably 1.13 to 1.126, particularly preferably 1.13 to 1.24.

The melt leaving this reactor is brought to the desired final viscosity or the final molecular weight in a further disc or basket reactor. The temperatures are 270 to 330° C., preferably 280 to 320° C., particularly preferably 280 to 310° C., and the pressure is 0.01 to 3 mbar, preferably 0.2 to 2 mbar, during residence times of 60 to 180 minutes, preferably 75 to 150 minutes. The relative viscosities are adjusted to the level required for the intended application and are 1.18 to 1.40, preferably 1.18 to 1.36, particularly preferably 1.18 to 1.134.

The polycarbonate thus obtained ideally contains less than 350 ppm of diphenyl carbonate (DPC), less than 40 ppm of 2,2-bis(4-hydroxyphenyl)propane (BPA) and less than 150 ppm of phenol, preferably less than 300 ppm of DPC, less than 30 ppm of BPA and less than 100 ppm of phenol, particularly preferably less than 250 ppm of DPC, less than 20 ppm of BPA and less than 80 ppm of phenol, and especially particularly preferably less than 200 ppm of DPC, less than 15 ppm of BPA and less than 70 ppm of phenol.

The function of the two basket reactors can also be combined in one basket reactor.

The vapours from all process stages are immediately removed, collected and worked up. This working-up is effected as a rule by distillation in order to achieve high purities of the substances recovered. This can be effected, for example, according to DE-A 10 100 404. Recovery and isolation of the eliminated monohydroxyaryl compound in very pure form are self-evident from economic and ecological points of view. The monohydroxyaryl compound can be used directly for the preparation of a dihydroxyaryl compound or of a diaryl carbonate.

The disc or basket reactors are distinguished in that they provide a very large, continuously renewing surface area in vacuo during long residence times. The disc or basket reactors are geometrically formed according to the melt viscosities of the products. For example, reactors as described in DE 44 47 422 C2 and EP-A 1253 163 or twin-shaft reactors as described in WO-A 99/28 370 are suitable.

The above-described particularly preferred embodiment of the process according to the invention can also be used for the reaction of dihydroxyaryl compounds or diaryl carbonates other than 2,2-bis(4-hydroxyphenyl)propane (bisphenol A, BPA) and diphenyl carbonate (DPC), respectively. If appropriate, adaptations of the temperature and pressure settings in the individual process stages may be necessary.

The oligocarbonates, including very low molecular weight ones, and the final polycarbonates are transported as a rule by means of gear pumps, screws having a very wide range of designs and positive displacement pumps of special design.

Particularly suitable materials for the production of the apparatuses, reactors, pipelines, pumps and fittings are stainless steels of type Cr Ni (Mo) 18/10, such as, for example, 1.4571 or 1.4541 (Steel key 2001, published by: Stahlschlüssel Wegst GmbH, Th-Heuss-Strasse 36, D-71672 Marbach) and Ni-based alloys of the type C, such as, for example, 2.4605 or 2.4610 (Steel key 2001, published by: Stahlschlüssel Wegst GmbH, Th-Heuss-Strasse 36, D-71672 Marbach). The stainless steels are used up to process temperatures of about 290° C. and the Ni-based alloys at process temperatures above about 290° C.

The substantial process parameters, such as ratio of diaryl carbonate to dihydroxyaryl compound at the beginning of the process, pressure, temperature and residence time should be chosen in the total plant before the final or finish reactor so that a molecular weight sufficient for the intended use of the product to be prepared and certain terminal OH group contents are reached before entry of the reaction melt into the final or finish reactor. The final molecular weight is dependent substantially on the chosen exit temperature of the reactor, the pressure and the terminal OH group concentration. These conditions should therefore be chosen in the penultimate reactor in order to be able to prepare the desired end product. The content of terminal OH groups in the polycarbonates is preferably above 150 ppm, particularly preferably above 250 ppm, very particularly preferably above 350 ppm. A terminal OH group content between 150 and 750 ppm is particularly preferred, preferably between 250 and 650 ppm, particularly preferably between 350 and 600 ppm.

In order to obtain a low content of residual monomers, the melt should be thoroughly mixed with at least one of the abovementioned suitable inhibitors before the finish reactor, preferably between penultimate and final reactor or before a devolatilization apparatus, in order to stop the reaction. The monomers can then be evaporated in the finish reactor (or devolatilization apparatus).

The polycarbonate prepared by the process according to the invention is suitable in particular for optionally rewritable optical data media having good coatability and wettability and little tendency to soiling. In addition, a low level of deposits on moulds or on the corresponding shaped articles or extrudates occurs during the processing of the polycarbonate to give shaped articles or extrudates.

The polycarbonate prepared by the process according to the invention is also suitable for the production of injection moulded articles, which have surprisingly low values for the electric field strength and high charge homogeneity. For injection moulded articles which were produced by means of known injection processes without the use of ionizers, for example, values in an acceptable range from −20 kV/m to +20 kV/m can be achieved for the average electric field strength and an average variation of the electric field strength of less than 15 kV/m.

Such polycarbonates prepared by means of melt transesterification methods have not been available to date and are not described in the literature.

The invention therefore also relates to the polycarbonates prepared from the process according to the invention.

These polycarbonates preferably have a content of phenolic terminal OH groups of more than 150 ppm, preferably more than 200 ppm, particularly preferably more than 250 ppm.

The amount of terminal OH groups can be determined by NMR measurement, IR measurement or on-line IR measurement of the terminal OH groups. Furthermore, the OH groups can be determined photometrically. The IR method and the photometric method are described in Horbach, A.; Veiel, U.; Wunderlich, H., Makromolekulare Chemie [Macromolecular Chemistry] 1965, volume 88, pages 215-231. The values stated in connection with the invention for the content of phenolic OH groups were determined by means of IR measurement.

Injection moulded bodies comprising conventional polycarbonate prepared by the melt transesterification process have the property of building up high and locally inhomogeneous electric fields at the surface of the injection moulded article. Thus, for example, discs for optical data media comprising this polycarbonate build up a high electric field during their production in the injection moulding process. This high field strength on the substrate leads, for example, to the attraction of dust from the environment or to sticking of the injection moulded articles, for example discs, to one another, during the production of the optical data stores, which reduces the quality of the finished injection moulded articles and also makes the injection moulding process more complicated.

Furthermore, the buildup of electrostatic charge, in particular on discs (for optical data media) leads to poor wettability especially with nonpolar media, such as, for example, a nonpolar dye or a dye coat comprising solvents, such as, for example, dibutyl ether, ethylcyclohexane, tetrafluoropropanol, cyclohexane, methylcyclohexane or octafluoropropanol. Thus, a high buildup of electric charge on the surface of the substrate causes, for example, irregular and incomplete coating with dye during the dye application in the case of writable data stores and thus leads to defects in the information layer.

It has been found that the polycarbonates according to the invention are particularly suitable for giving injection-moulded articles which, after a certain production period, do not exceed a certain electric field strength, measured at a defined distance from the substrate surface and at a defined temperature and atmospheric humidity. In order to achieve acceptable coating behaviour, it is desirable that an electric field strength of ±20 kV/m is not exceeded after 2 hours of a continuous injection moulding process and the electrostatic field on the disc surface is very homogeneous, i.e. has little field strength variation. The values achieved for the polycarbonates according to the invention for the average electric field strength are preferably from −20 to +20 kV/m and have a small field strength variation of less than 15 kV/m after 2 hours of a continuous injection moulding process. The values for the electric field strength are established in general within an hour and change only slightly or not at all thereafter per unit time. The abovementioned values of the electric field strength for the substrate materials according to the invention can also be achieved without the use of ionizers, so that the use of ionizers can be substantially reduced in the further processing of the polycarbonates.

An injection moulded body comprising polycarbonate, such as, for example, an optical disc, having the abovementioned properties with regard to the electric field strength is distinguished by good coatability with dyes. This is important for ensuring defect-free application of the writable layer and hence a trouble-free production process. This leads to a substantially reduced spoilage rate compared with conventional substrate materials.

Owing to surface charges on the corresponding substrate, the electric field strength is dependent on the geometry and the dimensions of the injection moulded body and the type of injection moulding process. The measurement of the electric field strength should therefore be carried out on a finished injection moulded body, such as, for example, a disc for an optical data medium.

The low values for the electric field strength are particularly surprising in view of the relatively high content of phenolic OH groups in the polycarbonates according to the invention.

The weight average molecular weight of the polycarbonate is in general M_{w}=10 000 to 40 000 g/mol, preferably 15 000 to 36 000 and particularly preferably 18 000 to 35 000 g/mol. The weight average molecular weight is determined via the intrinsic viscosity according to the Mark-Houwink correlation (G. V. Schulz, H. Horbach, Makcromol. Chem. 1959, 29, 93). The intrinsic viscosity is obtained if the viscosity of a polycarbonate solution in methylene chloride at 25° C. is determined by means of an Ubbelohde capillary viscometer according to DIN EN ISO 1628. The weight-average molecular weight for polycarbonate is obtained via the Mark-Houwink relationship according to [η]=K×M_{w}^{α} ([η]: intrinsic viscosity; K: 11.1×10⁻³ ml/g; α: 0.82).

The polycarbonates also preferably have an extremely low content of salt-like impurities. The amount of alkali metal or alkaline earth metal ions resulting from salt-like impurities, determined by atomic absorption spectroscopy should be less than 60 ppb, preferably less than 40 ppb and particularly preferably less than 20 ppb. The salt-like impurities may originate, for example, from impurities from the raw materials used and the phosphonium and ammonium salts. Further ions, such as Fe, Ni, Cr, Zn, Sn, Mo or Al ions and their homologues, may be present in the raw materials or may originate through removal or corrosion from the materials of the plant used. The content of these ions is in total less than 2 ppm, preferably less than 1 ppm, and particularly preferably less than 0.5 ppm.

Anions present are those of inorganic acids and of organic acids in equivalent amounts (e.g. chloride, sulphate, carbonate, phosphate, phosphite, oxalate, etc.).

Very small amounts of such cations and anions are strived for and it is for this reason that the use of raw materials which are as pure as possible is advantageous. Such pure raw materials can be obtained from the partly contaminated industrial raw materials, for example, by additional purification operations before the use thereof, such as, for example, by recrystallization, distillation, reprecipitation with washing and the like.

Furthermore, the polycarbonate according to the invention can be provided with further, customary additives (e.g. auxiliaries and reinforcing materials) for changing the properties. The addition of additives serves for lengthening the duration of use (e.g. hydrolysis stabilizers or degradation stabilizers), improving the colour stability (e.g. heat stabilizers and UV stabilizers), simplifying the process (e.g. demoulding agents, flow improvers), improving the performance characteristics, improving the flameproofing, influencing the optical impression (e.g. organic colorants, pigments) or adapting the polymer properties to certain loads (impact modifiers, finely divided minerals, fibrous materials, quartz powder and glass and carbon fibres). Such additives are described, for example, in “Plastics Additives”, R. Gächter and H. Müller, Hanser Publishers 1983.

The amounts of flameproofing agents, demoulding agents, UV stabilizers and heat stabilizers are chosen in the manner known to the person skilled in the art for aromatic polycarbonates. However, for the reasons described at the outset, the amount of additives used should be kept as small as possible. Examples of such additives are demoulding agents based on stearic acid and/or stearyl alcohol, particularly preferably pentaerythrityl stearate, trimethylolpropane tristearate, pentaerythrityl distearate, stearyl stearate and glyceryl monostearate, and customary heat stabilizers.

In order to achieve the desired properties, the different additives can be combined with one another. These additives can be added individually or in any desired mixtures or a plurality of different mixtures to the polymer melt, in particular directly during the isolation of the polymer or after melting of granules in a so-called compounding step.

The additives or mixtures thereof can be added as solid, i.e. as powder, or as a melt to the polymer melt. Another method of metering is the use of masterbatches, i.e. a mixture of the additive with the polymer, preferably with polycarbonate, which mixture was homogenized via compounding, or mixtures of masterbatches of the additives or additive mixtures.

These substances are preferably added to the finished polycarbonate on conventional units.

Suitable additives are described, for example, in Additives for Plastics Handbook, John Murphy, Elsevier, Oxford 1999 or Plastics Additives Handbook Hans Zweifel, Hanser, Munich 2001.

The polycarbonates according to the invention are outstandingly suitable as substrate materials for transparent injection moulded parts, in particular for injection moulded parts to be coated, such as, for example, transparent plates, lenses, optical storage media or substrates for optical storage media or articles from the area of automotive glazings, such as, for example, diffuser discs. Thus, in particular optical storage media or substrates for optical storage media, such as, for example, writable optical data stores which have good coatability and wettability and, for example, are suitable for the application of dyes from solution, in particular from nonpolar media, can be produced from the polycarbonate according to the invention. In addition, the optical injection moulded parts which were produced from these polycarbonates have less tendency towards soiling.

The invention therefore also relates to the shaped articles or extrudates produced from the polycarbonates according to the invention, such as, for example, discs for writable optical data stores or materials from the area of automotive glazings, such as, for example, diffuser discs.

The invention also relates to optical discs which serve for the production of optical data stores. Optical discs in the context of this invention are the injection moulded articles which are produced by the injection moulding process with the aid of an injection moulding unit or an injection mould. The optical discs are produced from the substrate material and are neither coated nor aftertreated. A non-limiting production process for the optical discs is cited in the examples. Accordingly, the optical disc is the precursor of the optical data medium prior to coating and aftertreatment.

The following examples serve for the exemplary explanation of the invention but are in no way to be considered as limiting.

### EXAMPLES

### Intrinsic Viscosity/Molecular Weight

The weight-average molecular weight is determined via the intrinsic viscosity according to the Mark-Houwink correlation (G. V. Schulz, H. Horbach, Makromol. Chem. 1959, 29, 93). The intrinsic viscosity is obtained if the viscosity of a polycarbonate solution in methylene chloride at 25° C. is determined by means of an Ubbelohde capillary viscometer according to DIN EN ISO 1628. The weight-average molecular weight of polycarbonate is obtained via the Mark-Houwink relationship according to [η]=K×M_{w}^{α} ([η]: intrinsic viscosity; K: 11.1×10⁻³ ml/g; α: 0.82).

### Content of Phenolic Terminal OH Groups:

The content of phenolic terminal OH groups was determined by photometric determination of the TiCl₄ complex according to Horbach et. al. (Die Makromolekulare Chemie 88 (1965) 215-231).

### Measurement of the Electric Field Strength:

The measurements of the electric field strength were carried out on finished injection moulded parts, in the present case on discs. The following injection moulding parameters and conditions were set for the production of these optical discs:

### Machine: Netstal Discjet

Cavity: Audio stamper
Cycle time: 4.4 s
Melt temperature: 310-330° C.
Substrate dimensions: Audio CD
Mould temperature on cavity side: 60° C.
Before the beginning of the injection moulding process, a new audio stamper was inserted into the machine. Before insertion of the new stamper, the total injection moulding unit was cleaned to remove the preceding material so that the measured values were not falsified. Furthermore, discs were injection-moulded initially for two hours with a cycle time of 4.4 seconds; this ensures that a stable and representative state of the unit or of the discs with regard to the buildup of electrostatic charge was achieved. After a preliminary run time of 2 hours, the next 100 discs were all measured as follows:
Each of these discs was removed from the injection mould immediately after the end of the injection moulding process by means of a robot arm and placed on a turntable. The disc was held on this turntable only by means of four points in the outer region so that the load present on the disc (electrostatic field) was practically not adversely affected. After the turntable had brought the disc to a position where the measuring probe for measurement of the electric field strength (probe 3455E from TREK Inc., 1160 Maple Ridge Road, Medina, N.Y. 14103) was present, the disc was gripped in this position in the inner hole region with the aid of a lifter and raised about 2 cm. The disc was therefore present at a distance of 5 mm from the measuring probe, which was incidentally mounted so that its measuring range aimed at the radius of 35 mm of the disc. Thereafter, the disc was moved under the probe for one revolution with the aid of this lifter which was rotatable by means of a motor. The electrostatic field was recorded practically continuously (200 measuring points per revolution). For this purpose, the signals delivered by the probe were first transferred as an analogue signal to the measuring device (Model 341B from TREK Inc., 11601 Maple Ridge Rd., Medina, N.Y. 14103), converted there by means of an analogue-digital converter into digital measured values, which were acquired by means of suitable software. For each disc, 200 measured values were thus recorded and evaluated per revolution. The mean electric field strength (Fₘₑₐₙ) of the 200 values was calculated by determining the mean value, and the maximum and the minimum electric field strength (Fₘᵢₙ and Fₘₐₓ) in each case were determined. The values for Fₘₑₐₙ, Fₘᵢₙ and Fₘₐₓ present for each of the 100 discs were now averaged again in total. The mean electric field strength and the mean maximum and mean minimum electric field strength were thus obtained for the set of 100 discs. The difference between the mean maximum and mean minimum electric field strength was likewise determined by subtraction and designated below as field strength variation.

### Example 1

### Comparative Example

7500 kg/h of melt mixture comprising 3741 kg/h of diphenyl carbonate (17.45 kmol/h) and 3759 kg/h of bisphenol A (16.47 kmol/h) were pumped from a receiver, with addition of 4.19 kg/h of a catalyst mixture, through a heat exchanger, heated to 190° C. and fed through a dwell column at 12 bar and 190° C. The average residence time was 50 minutes. The catalyst mixture consisted of 0.52 kg of the phenol adduct of tetraphenylphosphonium phenolate (containing 65.5% by weight of tetraphenylphosphonium phenolate 0.786 mol) dissolved in 4.5 kg of phenol.
The melt was then passed via an expansion valve into a separator under a pressure of 200 mbar. The melt flowing away was heated again to 200° C. in a falling-film evaporator likewise under 200 mbar and was collected in a receiver. After a residence time of 20 minutes, the melt was pumped into the next three, similarly designed stages. The conditions of pressure, temperature and residence time in the 2nd/3rd/4th stage were 90/70/40 mbar; 223/252/279° C. and 20/10/10 minutes. All vapours were fed with pressure regulations into a column under a vacuum and removed as condensates.
Thereafter, the oligomer was subjected to condensation in a subsequent basket reactor at 280° C. and 4.7 mbar during a residence time of 45 minutes to give a higher molecular weight product, the relative viscosity of which was 1.195. The vapours were condensed.
A part-stream of 150 kg/h of melt was branched off by means of a gear pump from the melt stream which was passed into a further basket reactor, 2.0 g/h of 1,2,3-propanetriol tris(4-benzenesulphonate) were added, the mixture was fed via a static mixer having a length-to-diameter ratio of 20 and was recycled to the main melt stream. Directly after combination, the 1,2,3-propanetriol tris(4-benzenesulphonate) was homogeneously distributed in the total melt stream by means of a further static mixer. The melt thus treated was further subjected to the process conditions in a further basket reactor at 294° C. and 0.7 mbar and during an average residence time of 130 minutes, discharged and granulated.
The production of the optical shaped articles (discs) and the measurement of the electric field strength were effected as described below. For this purpose, the granules obtained were dried for 6 hours and then processed by means of a Netstal Discjet injection moulding machine (see above) during a cycle time of 4.4 seconds under the abovementioned parameters to give discs. The cavity used was an audio stamper. For stabilizing the process, discs were initially produced for two hours and then the mean electric field strength and the field strength variation were determined in each case for the following 100 discs.
The value of the mean electric field strength and the field strength variation of these 100 discs are shown in Tab. 1.
   Content of phenolic OH groups: 470 ppm
The intrinsic viscosity of the polymer is 36.5. This corresponds to a molecular weight of about M_{w}=19 450 g/mol.

### Examples 2-18

### Comparative Examples

The procedure was as in Example 1, except that, after the last basket reactor, i.e. the last process step, various aromatic and aliphatic carboxylic acids were added to the material. Spinning and granulation were then effected.
The production of the discs and the measurement of the electric field strength were effected as described above.
The aromatic and aliphatic carboxylic acids added in each case, amounts added and the results of the electric field strength measurement and of the phenolic OH content as well as the intrinsic viscosity are shown in Tab. 1.

### Example 19

### Comparative Example

Commercially available polycarbonate prepared by the melt transesterification method from General Electric (Lexan® OQ1025) was used. The production of the discs and the measurement of the electric field strength were effected as described above. The results are shown in Tab. 1.

### Examples 20-25

### According to the Invention

The procedure was as in Example 1, except that, after the last basket reactor, i.e. the last process step, various aliphatic hydroxydicarboxylic acids or hydroxypolycarboxylic acids were added to the material. Spinning and granulation were then effected.
The production of the discs and the measurement of the electric field strength were effected as described above.

The aliphatic hydroxydicarboxylic acids or hydroxypolycarboxylic acids added in each case, amounts added, the results of the field strength measurement and those of the phenolic OH contents of the polycarbonates obtained are shown in Tab. 2. The intrinsic viscosities for all examples and comparative examples are in the range from 35.0 to 40.0. This corresponds to molecular weights M_{w} from 18 500 to 21 750 g/mol. The preceding examples according to the invention surprisingly show substantially smaller buildup of electrostatic charge and smaller field strength variation compared with the comparative examples.

TABLE 1
(Comparative examples)

| | | Amount added | | Variation of | |
|---|---|---|---|---|---|
| | Type of addition | after last basket | Electric | the electric | Phenolic OH |
| Ex. | after last basket | reactor | field strength | field strength | content |
| No. | reactor | [ppm] | [kV/m] | [kV/m] | [ppm] |
| 1 | — | — | −13 | 22 | 470 |
| 2 | 12-Hydroxystearic | 50 | −41 | 36 | 550 |
| | acid | | | | |
| 3 | 12-Hydroxystearic | 200 | −29 | 25 | 550 |
| | acid | | | | |
| 4 | Mandelic acid | 50 | −34 | 32 | 530 |
| 5 | Mandelic acid | 200 | −51 | 39 | 530 |
| 6 | Adipic acid | 50 | −43 | 18 | |
| 7 | Adipic acid | 200 | −18 | 20 | 470 |
| 8 | Lactic acid | 200 | −38 | 18 | 460 |
| 9 | Salicylic acid | 50 | +1 | 18 | 470 |
| 10 | Salicylic acid | 100 | +12 | 23 | 510 |
| 11 | Salicylic acid | 200 | +29 | 28 | 510 |
| 12 | Stearic acid | 50 | −40 | 23 | 510 |
| 13 | Stearic acid | 200 | −30 | 23 | 510 |
| 14 | Oxalic acid | 200 | −30 | 15 | 450 |
| 15 | Terephthalic acid | 50 | −54 | 37 | 470 |
| 16 | Terephthalic acid | 200 | −47 | 57 | 450 |
| 17 | Isophthalic acid | 50 | −49 | 39 | 520 |
| 18 | Isophthalic acid | 200 | −23 | 19 | 560 |
| 19 | Lexan ®OQ 1025 | — | −36 | 69 | 230 |

TABLE 2
(Examples according to the invention)

| | | Amount added | | Variation of | |
|---|---|---|---|---|---|
| | Type of addition | after last basket | Electric | the electric | Phenolic OH |
| Ex. | after last basket | reactor | field strength | field strength | content |
| No. | reactor | [ppm] | [kV/m] | [kV/m] | [ppm] |
| 20 | Tartaric acid | 30 | +5 | 9 | 440 |
| 21 | Tartaric acid | 50 | 0 | 8 | 440 |
| 22 | Tartaric acid | 100 | 9 | 8 | 450 |
| 23 | Malic acid | 50 | −18 | 12 | 550 |
| 24 | Malic acid | 100 | −6 | 12 | 570 |
| 25 | Malic acid | 200 | +20 | 10 | 570 |

In Tab. 3 and 4, the individual electrostatic field measurements for Example 2 and Example 21 are shown in detail by way of example:

For each disc, a mean electric field strength (Fₘₑₐₙ) was determined from the 200 individual values acquired per revolution. Furthermore, the respective minimum field strength value (Fₘᵢₙ) determined per disc and the respective maximum field strength value (Fₘₐₓ) were determined. The mean values for all 100 discs were then calculated from Fₘₑₐₙ, Fₘᵢₙ and Fₘₐₓ.

TABLE 3
(Individual results for electrostatic
field measurements for Example 2)

| Individual disc | Fₘₑₐₙ | Fₘᵢₙ | Fₘₐₓ |
|---|---|---|---|
| number | (kV/m) | (kV/m) | (kV/m) |
| 1 | −43.7 | −59.5 | −21.2 |
| 2 | −43.7 | −60.4 | −24.5 |
| 3 | −38.4 | −59.7 | −20.7 |
| 4 | −39.0 | −55.1 | −18.5 |
| 5 | −45.0 | −61.2 | −22.7 |
| 6 | −40.5 | −57.0 | −23.6 |
| 7 | −41.1 | −58.5 | −24.4 |
| 8 | −41.0 | −57.9 | −25.2 |
| 9 | −41.0 | −63.5 | −28.3 |
| 10 | −40.9 | −62.9 | −21.0 |
| 11 | −39.6 | −57.0 | −23.1 |
| 12 | −42.6 | −60.9 | −21.4 |
| 13 | −37.9 | −60.7 | −18.9 |
| 14 | −43.0 | −57.5 | −24.7 |
| 15 | −41.0 | −64.4 | −27.1 |
| 16 | −42.4 | −58.7 | −26.1 |
| 17 | −42.0 | −56.5 | −23.8 |
| 18 | −41.4 | −60.9 | −23.0 |
| 19 | −42.6 | −63.4 | −20.3 |
| 20 | −41.2 | −60.5 | −23.4 |
| 21 | −47.2 | −63.0 | −23.2 |
| 22 | −48.2 | −62.4 | −27.2 |
| 23 | −41.3 | −56.8 | −23.4 |
| 24 | −42.2 | −63.3 | −25.7 |
| 25 | −41.3 | −61.4 | −19.7 |
| 26 | −40.0 | −58.2 | −21.1 |
| 27 | −40.4 | −58.3 | −20.7 |
| 28 | −40.7 | −63.5 | −21.5 |
| 29 | −42.5 | −57.5 | −23.7 |
| 30 | −37.6 | −59.9 | −18.8 |
| 31 | −40.7 | −55.9 | −22.9 |
| 32 | −40.0 | −60.8 | −21.4 |
| 33 | −35.9 | −56.6 | −21.0 |
| 34 | −44.8 | −54.8 | −27.9 |
| 35 | −41.2 | −57.2 | −24.7 |
| 36 | −41.9 | −61.7 | −22.3 |
| 37 | −40.4 | −61.9 | −20.4 |
| 38 | −48.1 | −60.3 | −29.0 |
| 39 | −38.3 | −59.4 | −16.6 |
| 40 | −25.2 | −38.1 | −15.5 |
| 41 | −39.8 | −58.0 | −21.1 |
| 42 | −39.2 | −60.4 | −20.0 |
| 43 | −40.0 | −59.0 | −21.0 |
| 44 | −41.4 | −61.0 | −19.6 |
| 45 | −38.9 | −60.0 | −20.2 |
| 46 | −20.8 | −27.2 | −13.8 |
| 47 | −39.4 | −58.3 | −18.5 |
| 48 | −39.7 | −60.0 | −22.3 |
| 49 | −41.8 | −60.5 | −23.7 |
| 50 | −41.3 | −61.4 | −29.3 |
| 51 | −46.8 | −63.1 | −27.4 |
| 52 | −24.0 | −31.1 | −17.2 |
| 53 | −35.5 | −56.3 | −18.2 |
| 54 | −40.8 | −57.5 | −24.8 |
| 55 | −42.4 | −61.8 | −19.3 |
| 56 | −38.8 | −61.7 | −25.6 |
| 57 | −40.5 | −58.7 | −22.0 |
| 58 | −42.1 | −62.7 | −27.4 |
| 59 | −39.8 | −57.7 | −24.3 |
| 60 | −45.3 | −60.7 | −27.9 |
| 61 | −42.2 | −56.0 | −21.7 |
| 62 | −37.6 | −57.8 | −19.2 |
| 63 | −41.2 | −61.6 | −20.9 |
| 64 | −34.8 | −55.1 | −18.7 |
| 65 | −39.6 | −58.9 | −18.4 |
| 66 | −41.5 | −60.4 | −20.4 |
| 67 | −41.5 | −60.2 | −18.7 |
| 68 | −43.2 | −61.6 | −25.8 |
| 69 | −41.1 | −58.1 | −28.7 |
| 70 | −43.6 | −61.0 | −20.8 |
| 71 | −40.2 | −61.9 | −23.2 |
| 72 | −40.7 | −58.4 | −22.6 |
| 73 | −47.1 | −61.8 | −30.1 |
| 74 | −42.4 | −55.7 | −23.0 |
| 75 | −43.4 | −58.7 | −28.5 |
| 76 | −39.0 | −54.0 | −18.3 |
| 77 | −39.7 | −53.8 | −20.2 |
| 78 | −23.4 | −38.9 | −14.5 |
| 79 | −42.1 | −60.7 | −19.0 |
| 80 | −43.3 | −59.5 | −27.8 |
| 81 | −44.8 | −61.8 | −23.0 |
| 82 | −42.1 | −58.9 | −21.7 |
| 83 | −42.3 | −58.0 | −19.7 |
| 84 | −40.0 | −60.0 | −17.4 |
| 85 | −44.9 | −57.0 | −26.2 |
| 86 | −44.5 | −56.3 | −24.7 |
| 87 | −42.3 | −58.7 | −25.7 |
| 88 | −33.3 | −52.3 | −17.8 |
| 89 | −43.9 | −59.8 | −27.6 |
| 90 | −39.6 | −55.8 | −23.9 |
| 91 | −43.4 | −63.0 | −23.3 |
| 92 | −40.6 | −57.2 | −19.6 |
| 93 | −41.9 | −61.8 | −22.8 |
| 94 | −42.8 | −58.8 | −25.4 |
| 95 | −46.1 | −63.5 | −27.2 |
| 96 | −43.9 | −61.4 | −22.4 |
| 97 | −48.8 | −61.6 | −32.4 |
| 98 | −42.8 | −61.3 | −22.6 |
| 99 | −27.1 | −36.7 | −19.0 |
| 100 | −45.4 | −65.8 | −20.6 |
| Mean value | −40.7 | −58.3 | −22.6 |
| for all 100 | | | |
| discs | | | |

The mean values found were −40.7 kV/m (rounded up to −41 kV/m) for Fₘₑₐₙ, −58.3 kV/m for Fₘᵢₙ and −22.6 kV/m for Fₘₐₓ. The difference between the mean maximum and mean minimum electric field strength Fₘₐₓ and Fₘᵢₙ, which is referred to as field strength variation in the context of the invention, is thus −22.6−(−58.3)=35.7 kV/m (rounded up to 36 kV/m).

TABLE 4
(Individual results for electrostatic
field measurement for Example 21)

| Individual disc | Fₘₑₐₙ | Fₘᵢₙ | Fₘₐₓ |
|---|---|---|---|
| number | (kV/m) | (kV/m) | (kV/m) |
| 1 | −0.3 | −5.1 | 2.9 |
| 2 | 0.1 | −3.2 | 2.9 |
| 3 | 0.3 | −4.0 | 3.7 |
| 4 | 1.5 | −3.5 | 4.6 |
| 5 | −2.0 | −5.1 | 0.7 |
| 6 | 0.3 | −3.8 | 4.8 |
| 7 | 0.5 | −4.0 | 5.2 |
| 8 | 0.4 | −2.9 | 4.2 |
| 9 | 0.6 | −5.3 | 3.6 |
| 10 | 1.0 | −4.3 | 3.7 |
| 11 | −1.2 | −5.6 | 2.2 |
| 12 | 0.0 | −4.6 | 2.5 |
| 13 | 0.9 | −4.1 | 3.8 |
| 14 | 0.6 | −5.3 | 3.2 |
| 15 | 0.2 | −4.9 | 2.9 |
| 16 | −0.7 | −4.2 | 2.2 |
| 17 | 0.6 | −3.9 | 3.9 |
| 18 | −0.1 | −3.7 | 2.3 |
| 19 | −2.5 | −8.3 | 2.0 |
| 20 | 0.4 | −5.1 | 4.4 |
| 21 | −0.1 | −4.9 | 3.8 |
| 22 | 0.8 | −3.8 | 3.4 |
| 23 | 0.9 | −3.4 | 3.1 |
| 24 | 0.8 | −4.3 | 3.4 |
| 25 | 0.7 | −6.4 | 4.9 |
| 26 | −0.9 | −4.9 | 2.3 |
| 27 | 1.2 | −4.8 | 4.0 |
| 28 | 0.1 | −5.0 | 4.8 |
| 29 | −0.7 | −4.8 | 1.7 |
| 30 | 0.2 | −3.5 | 2.3 |
| 31 | 1.3 | −4.2 | 4.0 |
| 32 | 0.3 | −10.0 | 5.9 |
| 33 | −0.5 | −3.8 | 3.0 |
| 34 | 0.4 | −4.4 | 3.0 |
| 35 | −0.9 | −7.2 | 2.4 |
| 36 | 0.3 | −5.3 | 3.2 |
| 37 | 0.2 | −3.6 | 2.7 |
| 38 | −2.0 | −6.4 | 2.4 |
| 39 | 0.0 | −4.8 | 3.4 |
| 40 | 0.9 | −3.0 | 3.1 |
| 41 | 0.9 | −3.6 | 3.5 |
| 42 | 0.5 | −4.1 | 4.4 |
| 43 | 0.6 | −4.6 | 3.6 |
| 44 | −1.6 | −8.1 | 2.8 |
| 45 | −0.2 | −4.3 | 4.7 |
| 46 | −0.8 | −5.6 | 2.4 |
| 47 | 0.7 | −4.8 | 3.3 |
| 48 | 0.7 | −3.7 | 3.3 |
| 49 | −0.8 | −4.6 | 2.0 |
| 50 | 0.1 | −4.3 | 2.7 |
| 51 | −1.2 | −4.7 | 2.5 |
| 52 | −0.2 | −7.0 | 3.5 |
| 53 | 0.4 | −2.5 | 2.8 |
| 54 | 0.5 | −3.2 | 3.2 |
| 55 | 1.1 | −2.7 | 3.7 |
| 56 | −1.6 | −10.0 | 2.2 |
| 57 | 1.1 | −2.7 | 3.4 |
| 58 | 1.7 | −3.4 | 4.4 |
| 59 | 1.6 | −4.3 | 4.4 |
| 60 | 1.2 | −3.7 | 4.5 |
| 61 | 1.1 | −4.5 | 4.1 |
| 62 | 1.2 | −10.7 | 5.1 |
| 63 | −0.7 | −6.0 | 2.2 |
| 64 | 1.1 | −3.1 | 3.3 |
| 65 | 1.7 | −0.3 | 3.4 |
| 66 | 0.7 | −8.3 | 4.3 |
| 67 | 1.4 | −3.6 | 4.1 |
| 68 | −1.1 | −10.0 | 2.6 |
| 69 | 0.6 | −4.0 | 3.1 |
| 70 | 0.5 | −3.5 | 3.6 |
| 71 | 0.5 | −4.5 | 3.8 |
| 72 | −1.0 | −4.8 | 2.6 |
| 73 | −1.0 | −4.4 | 1.6 |
| 74 | 0.4 | −4.0 | 5.4 |
| 75 | 0.9 | −3.6 | 4.3 |
| 76 | −0.8 | −5.2 | 2.7 |
| 77 | −1.1 | −7.4 | 2.0 |
| 78 | −0.3 | −6.0 | 2.7 |
| 79 | −0.5 | −4.7 | 2.8 |
| 80 | 1.5 | −3.8 | 4.1 |
| 81 | 1.1 | −3.2 | 4.0 |
| 82 | 0.6 | −4.0 | 2.8 |
| 83 | −0.2 | −6.6 | 4.1 |
| 84 | 1.3 | −3.1 | 3.5 |
| 85 | 1.2 | −3.4 | 3.5 |
| 86 | −0.7 | −9.1 | 2.4 |
| 87 | 1.3 | −3.4 | 4.1 |
| 88 | 1.2 | −3.9 | 4.4 |
| 89 | 1.2 | −7.5 | 4.5 |
| 90 | 0.8 | −3.9 | 3.3 |
| 91 | 1.7 | −3.6 | 4.4 |
| 92 | 0.0 | −4.2 | 3.7 |
| 93 | 0.8 | −4.2 | 4.1 |
| 94 | 0.7 | −3.8 | 3.9 |
| 95 | 1.1 | −3.9 | 3.9 |
| 96 | 0.0 | −2.4 | 2.6 |
| 97 | −1.5 | −6.2 | 2.0 |
| 98 | 0.7 | −4.1 | 4.4 |
| 99 | 1.0 | −3.8 | 4.3 |
| 100 | 1.2 | −4.1 | 4.4 |
| Mean value | 0.3 | −4.7 | 3.4 |
| for all 100 | | | |
| discs | | | |

The mean values found were 0.3 kV/m (rounded down to 0 kV/m) for Fₘₑₐₙ, −4.7 kV/m for Fₘᵢₙ and 3.4 kV/m for Fₘₐₓ. The difference between the mean maximum and mean minimum electric field strength Fₘₐₓ and Fₘᵢₙ, which is referred to as field strength variation in the context of the invention, is thus 3.4−(−4.7)=8.1 kV/m (rounded down to 8 kV/m).

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

1. A process for preparing polycarbonate by the melt transesterification method comprising reacting at least one dihydroxyaryl compound with at least one diarylcarbonate in the presence of at least one catalyst in a multistage process, wherein at least one inhibitor is added to the melt before the last reaction stage and one or more aliphatic hydroxydicarboxylic acid(s) and/or hydroxypolycarboxylic acid(s) or derivative(s) thereof are added in or after the last reaction stage.

2. The process of claim 1, wherein said one or more aliphatic hydroxydicarboxylic acid(s) and/or hydroxypolycarboxylic acid(s) or derivative(s) thereof are one or more compound(s) of general formulae (VI) or (VII) 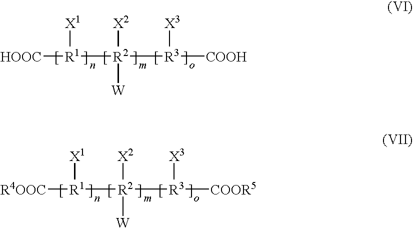
wherein
R¹, R², and R³
are, independently of one another, a linear or branched C₁-C₁₀-alkylene radical;
X¹, X² and X³
are, independently of one another, H or OH, wherein at least one of X¹, X², or X³ represent OH;
W is H, COOH, a carboxylate, or alkylcarboxyl;
n is an integer from 1 to 3;
m is 0 or an integer from 1 to 3;
o is 0 or an integer from 1 to 3; and
R⁴ and R⁵
are, independently of one another, a linear or branched C₁-C₁₀-alkyl radical or an alkali metal cation, preferably Li⁺, Na⁺ or K⁺.

3. The process of claim 2, wherein
R¹, R², and R³
are, independently of one another, a linear, C₁-C₆-alkylene radical;
W is COOH;
n is 1;
m is 0 or 1;
o is 0 or 1; and
R⁴ and R⁵
are, independently of one another, a linear or branched C₁-C₆-alkyl radical.

4. The process of claim 1, wherein said one or more aliphatic hydroxydicarboxylic acid(s) and/or hydroxypolycarboxylic (s) or derivative(s) thereof are one or more compound(s) selected from the group consisting of malic acid, malic acid esters, malic acid monoesters, tartaric acid, tartaric acid esters, tartaric acid monoesters, hydroxymalonic acid, hydroxymalonic acid esters, citric acid, and citric acid esters.

5. The process of claim 1, wherein said at least one inhibitor is a sulphur-containing acid, an ester of an organic sulphur-containing acid, or mixtures thereof.

6. The process of claim 1, wherein said at least one dihydroxyaryl compound is selected from the group consisting of dihydroxybenzenes, dihydroxybiphenyls, bis(hydroxyphenyl)alkanes, bis(hydroxyphenyl)cycloalkanes, bis(hydroxyphenyl)aryls, bis(hydroxyphenyl)ethers, bis(hydroxyphenyl)ketones, bis(hydroxyphenyl)sulphides, bis(hydroxyphenyl)sulphones, bis(hydroxyphenyl) sulphoxides, 1,1′-bis(hydroxyphenyl)diisopropylbenzenes, and derivatives thereof and is alkylated or halogenated on the nucleus.

7. The process of claim 1, wherein said at least one diarylcarbonate has a general formula (II) 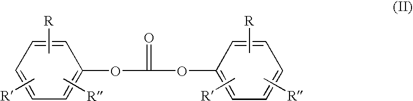
wherein
R, R′, and R″,
are, independently of one another, hydrogen, linear, or branched C₁-C₃₄-alkyl, C₇-C₃₄-alkylaryl, or C₆-C₃₄-aryl, wherein R is optionally COO—R′″, wherein R′″ is hydrogen, linear or branched C₁-C₃₄-alkyl, C₇-C₃₄-alkylaryl, or C₆-C₃₄-aryl.

8. The process of claim 1, wherein said at least one catalyst is a compound selected from the group consisting of alkali metal salts, alkaline earth metal salts, and onium salts.

9. The process of claim 8, wherein said at least one catalyst is an onium salt.

10. A polycarbonate prepared by the process of claim 1, wherein said polycarbonate comprises one or more aliphatic hydroxydicarboxylic acid(s) and/or hydroxypolycarboxylic acid(s) or derivative(s) thereof in an amount of from 5 to 500 ppm and has a content of phenolic terminal OH groups of more than 150 ppm.

11. A shaped article or extrudate comprising the polycarbonate of claim 10.

12. An optical data store or diffuser disc comprising the polycarbonate of claim 10.

13. An optical disc having a mean electric field strength of −20 to +20 kV/m and a field strength variation of less than 15 kV/m for producing optical data stores comprising a polycarbonate comprising one or more aliphatic hydroxydicarboxylic acid(s) and/or hydroxypolycarboxylic acid(s) or derivative(s) thereof in an amount of from 5 to 500 ppm and which has a content of phenolic terminal OH groups of more than 150 ppm.
